(19) United States
(12) Patent Application Publication
(10) Pub. No.: US 2014/0282057 A1
(43) Pub. Date: Sep. 18, 2014

(54) SYSTEM FOR APPLYING APPLICATIONS OF DIFFERENT OPERATING SYSTEMS IN ONE ELECTRONIC DEVICE AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/205,389

(22) Filed: Mar. 12, 2014

(30) Foreign Application Priority Data
Mar. 15, 2013 (CN) 201310083328X

(51) Int. Cl. G06F 3/0484; H04L 12/24; G06F 3/0481

(52) U.S. Cl. CPC G06F 3/04842; G06F 3/04817; H04L 41/22
USPC 715/744

(57) ABSTRACT

A method for applying a number of applications of different operating systems in one electronic device, includes: providing an icon interface and displaying the icon interface on a display unit of the electronic device. Detecting operations on the icon interface by a user and determining an icon selected by the user. Determining relationship information corresponding to the selected icon, and analyzing the relationship information to determine an application corresponding to the selected icon and determine an operating system supporting the application. Searching an operating system server running the operating system supporting the application, triggering the determined operating system server to execute the application corresponding to the selected icon. In addition, displaying an application interface of the operating system server on the display unit of the electronic device.

### CROSS REFERENCE TO RELATED APPLICATIONS

This application is related to the following co-pending, commonly assigned patent applications, the disclosures of which are incorporated herein by reference in their entirety:
1. “ELECTRONIC DEVICE WITH A FUNCTION OF APPLYING APPLICATIONS OF DIFFERENT OPERATING SYSTEMS AND METHOD THEREOF” by Steve Lap Wai Hui, whose Attorney Docket No is US51415.
2. “ELECTRONIC DEVICE WITH A FUNICTION OF APPLYING APPLICATIONS OF DIFFERENT OPERATING SYSTEMS AND METHOD THEREOF” by Steve Lap Wai Hui, whose Attorney Docket No is US51416.
3. “ELECTRONIC DEVICE WITH A FUNICTION OF APPLYING APPLICATIONS OF DIFFERENT OPERATING SYSTEMS, SYSTEM AND METHOD THEREOF” by Steve Lap Wai Hui, whose Attorney Docket No is US51417.
4. “SYSTEM FOR UPDATING ICON INTERFACE WITH ICONS OF DIFFERENT OPERATING SYSTEMS AND METHOD THEREOF” by Steve Lap Wai Hui, whose Attorney Docket No is US51418.

### BACKGROUND

1. Technical Field

The present disclosure relates to systems, and particularly to a system capable of applying a number of applications of different operating systems in one electronic device and an applying method.

2. Description of Related Art

Electronic devices, such as mobile phones and tablet computers, are popular. Electronic devices usually has a certain operating system installed, such as, a WINDOWS operating system, a LINUX operating system, an ANDROID operating system. However, a general electronic device is only capable of installing applications supported by the operating system installed in the electronic device, and cannot install applications which are not supported by the operating system installed in the electronic device. For example, an ANDROID application only can be installed in the electronic device with the ANDROID operating system, and cannot be installed in the electronic device installing the WINDOWS operating system. Therefore, if an application developer just develops an application for one operating system, a electronic device with another operating system then cannot install and apply the application.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a system for applying a number of applications of different operating systems in one electronic device.

FIG. 2 is a schematic diagram of a first embodiment of an electronic device connected to a host server.

FIG. 3 is a schematic diagram of an embodiment of an icon interface.

FIG. 4 is a schematic diagram of another embodiment of an icon interface.

FIG. 5 is a schematic diagram of a second embodiment of an electronic device connected to a host server.

FIG. 6 is a flowchart diagram of an embodiment of a method for applying a number of applications of different operating systems in one electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

FIG. 1 shows an embodiment of a system 100 for applying a number of applications of different operating systems in one electronic device. The system 100 includes a number of modules, which are collection of software instructions executed by a processor. The modules include an interface providing module 11, an operation detection module 12, an information analysis module 13, a server determination module 14, and an execution controlling module 15.

FIG. 2 shows that in a first embodiment, the system 100 is implemented in a host server 230. The host server 230 is connected to an electronic device 200 and a number of operating system servers 300 via corresponding networks. In the embodiment, each operating system server 300 installs/runs one or more operating systems. For example, as shown in FIG. 2, a first operating system server 300 installs and runs a LINUX operating system, a second operating system server 300 runs a WINDOWS operating system, a third operating system server 300 runs an ANDROID system, and a fourth operating system server 300 runs a MAC operating system.

In the embodiment, the host server 230 includes a processing unit 231, the system are collection of software instructions and executed by the by the processing unit 231. The processing unit 231 can be a central processing unit, a digital processor, or a single chip, for example.

The electronic device 200 includes a display unit 201 and a communication unit 202. In the embodiment, the display unit 201 is a touch screen, in another embodiment, the display unit 201 can be a display screen and the display unit 201 combines a keyboard or a touchpad to constitute an input/output device. The electronic device 200 communicates with the host server 230 through the network via the communication unit 202. The network among the electronic device 200, the host server 230, and the number of operating system servers 300 can be an internet, an on-demand virtual lease line, a wireless network including WIFI and BLUETOOTH, a telecommunication network including a GPRS network, a CDMA network, or a broadcasting network. The network between the electronic device 200 and the host server 230 and the network between the host server 230 and the number of operating system server 300 can be the same or different. The networks can be public network or private network. The communication unit 202 can be a communication chip complying with the corresponding network.

In the embodiment, the electronic device 100 can be a mobile phone, a tablet computer, a portable computer, or a desktop computer, for example. In another embodiment, the electronic device 100 can be a thin client, namely, a computer terminal device in a client-server system installed with a few applications. The operating system server 300 and the host server 230 can be virtual machines or physical machines.

FIG. 3 shows that the interface providing module 11 is used to provide an icon interface TS and display the icon interface TS on the display unit 201. FIG. 3 shows that the icon interface TS includes a number of icons TI, each of which corresponds to an application running in an operating system. For example, the icons TI include a browser icon TI1 applied in the LINUX operating system, a media player 1 icon TI2 applied in the ANDROID system. As shown in FIG. 3, the icons TI corresponding to different operating systems are arranged in the icon interface TS randomly.

FIG. 4 shows that in another embodiment, each operating system is assigned with a corresponding area on the display unit 201 for locating the icons TI. For example, the icons TI belong to the same operating system are located on the same at least one row. Therefore, a user can operate and manage the icons TI of the same operating system conveniently.

In the embodiment, the interface providing module 11 provides the icon interface TS including the stored icons TI in response to an operation of connecting to the host server 230 by a user. In the embodiment, the operation of connecting to the host server 230 is an operation of connecting the electronic device 200 to the host server 230 via remote access.

The operation detection module 12 detects operations on the icon interface TI by the user and determines an icon TI selected by the user according to the operation of the user.

In the embodiment, each icon TI corresponds to one relationship information, the relationship information and the corresponding icon Ti are stored by associating with each other. The information analysis module 13 is used to determine relationship information corresponding to the selected icon TI, and analyze the relationship information to obtain/determine an application corresponding to the selected icon TI and an operating system running the application. In the embodiment, the relationship information and the corresponding icon TI are stored in the host server 230. The relationship information includes identification information of an application and identification information of a corresponding operating system. The information analysis module 13 then determines the application according to the identification information of the application and determines the operating system supporting the application according to the identification information of the operating system.

The server determination module 14 searches the operating system server 300 running the operating system determined by the information analysis module 13, namely the operating system runs the application corresponding to the selected icon TI. For example, if the information analysis module 13 determines the application corresponding to the selected icon TI is a music player, and the operating system running/supporting the music player is the ANDROID operating system, then the server determination module 14 searches the operating system server 300 running the ANDROID system.

In detail, the host server 230 stores network address, such as an internet protocol (IP) address of each operating system server 300. The server determination module 14 searches the operating system server 300 according to the network address of the operating system server 300 and accesses to the searched operating system server 300 according to the network address of the determined operating system server 300.

The execution controlling module 15 is used to trigger the determined operating system server 300 to execute the application corresponding to the selected icon TI. In the embodiment, the execution controlling module 15 sends the identification information of the application and an execution request to the determined operating system server 300, and then triggers the determined operating system server 300 to execute the corresponding application.

At the same time, the interface providing module 11 then displays an application interface of the operating system server 300 on the display unit 201 of the electronic device 200, when the operating system server 300 executes the application corresponding to the selected icon TI. In the embodiment, the application interface of the operating system server 300 is produced when the operating system server 300 executes the application. In the embodiment, the interface providing module 11 obtains the application interface from the operating system server 300 and then displays the obtained application interface on the display unit 201 of the electronic device 200. In another embodiment, the interface providing module 11 controls the electronic device 200 to connect with the operating system server 300, and controls to display the application interface of the operating system server 300 on the display unit 201 of the electronic device 200.

In the embodiment, the application of each icon TI displayed on the icon interface TS provided by the interface providing module 11 is stored in the operating system server 300, which runs the operating system supporting/running the application. For example, the LINUX operating system supports an application corresponding to one icon TI, then the operating system server 300 running the LINUX operating system stores the application corresponding to the icon TI.

In the embodiment, the icon interface TS is produced according to the following steps: when the user executes an operation of downloading and installing an application from an application market, the host server 230 installs the application in the corresponding operating system server 300 which runs the operating system supporting the application. The host server 230 then adds the icon TI corresponding to the currently installed application on the icon interface TS. Thus, if the user executes the operation of downloading and installing a number of applications running on different operating systems, the icon interface TS would provide the icons TI corresponding to the installed applications running on different operating systems.

In the embodiment, at least one operating system is installed and run in the host server 230. After the information analysis module 13 determines the operating system supporting the application corresponding to the selected icon TI, the execution controlling module 15 determines whether the operating system of the host server 230 is the same as the operating system determined by the information analysis module 13. If yes, the execution controlling module 15 controls the host server 230 to execute the application corresponding to the selected icon TI directly.

FIG. 5 shows that in a second embodiment, the electronic device 200 includes the display unit 201, the communication unit 202, a processing unit 203, and a storage unit 204.

In the second embodiment, the icons TI and the relationship information are stored in the storage unit 204 of the electronic device 200 instead of being stored in the host server 230. The interface providing module 11 is executed by the processing unit 203, and the operation detection module 12, the information analysis module 13, the server determination module 14, and the execution controlling module 15 are executed by the host server 230. In the second embodiment, the interface providing module 11 provides the icon interface TS including the stored icons and displays the icon interface TS on the display unit 201 after the electronic device 200 is started up. The processing unit 203 can be a central processing unit, a digital processor, a single chip, and the like. The storage unit 204 can be a hard disk, a flash memory, a compact disk, and the like.

FIG. 6 is a flowchart diagram illustrating a method for applying for applying a number of applications of different operating systems. At first, the interface providing module 11 provides the icon interface TS and display the icon interface TS on the display unit 201 (S401). In one embodiment, the interface providing module 11 is executed by the host server 230, and the interface providing module 11 provides the icon interface TS in response to an operation of connecting to the host server 230 by a user. In another embodiment, the interface providing module 11 is executed by the electronic device 200, and interface providing module 11 provides the icon interface TS of a certain operating system, such as the ANDROID operating system, after the electronic device 200 is started up completely.

The operation detection module 12 detects operations on the icon interface TI by a user and determines an icon TI selected by the user (S403).

The information analysis module 13 determines relationship information corresponding to the selected icon TI, and analyzes the relationship information to obtain/determine an application corresponding to the selected icon TI and an operating system running/supporting the application (S405). In one embodiment, the relationship information is stored in the host server 230. In another embodiment, the relationship information is stored in the storage unit 204 of the electronic device 200. The relationship information includes identification information of the application and identification information of the operating system supporting the application. The information analysis module 13 determines the application according to the identification information of the application and determines the operating system supporting the application according to the identification information of the operating system.

The server determination module 14 searches the operating system server 300 running the operating system determined by the information analysis module 13 (S407). For example, if the information analysis module 13 determines the application corresponding to the selected icon TI is a music player, and the operating system running/supporting the music player is the ANDROID operating system, then the server determination module 14 searches the operating system server 300 running the ANDROID operating system. Therein, the server determination module 14 searches the operating system server 300 according to the network address of the operating system server 300. In one embodiment, the network address of the operating system server 300 is stored in the host server 230. In another embodiment, the network address of the operating system server 300 is stored in the storage unit 204 of the electronic device 200.

The execution controlling module 15 triggers the searched operating system server 300 to execute the application corresponding to the selected icon TI (S409).

The interface providing module 11 displays an application interface produced by executing the application via the operating system server 300 on the display unit 201 of the electronic device 200 (S411).

According to the system 100 and method of the present disclosure, the user can share/apply the applications of different operating systems by using the one electronic device 200.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for applying a plurality of applications of different operating systems in one electronic device, the system applied in a host server and an electronic device with a display unit, the system comprising:
a plurality of modules which are collection of instructions executed by one or more processors of the host server and the electronic device, the modules comprising:
an interface providing module configured to provide an icon interface and display the icon interface on the display unit;
an operation detection module configured to detect operations on the icon interface by the user and determine an icon selected by the user;
an information analysis module configured to determine relationship information corresponding to the selected icon, and analyze the relationship information to determine an application corresponding to the icon and determine an operating system supporting the application;
a server determination module configured to search an operating system server running the operating system supporting the application and connected to the host server; and
an execution controlling module configured to trigger the determined operating system server to execute the application corresponding to the selected icon;
wherein, the interface providing module is further configured to display an application interface of the operating system server on the display unit of the electronic device, when the operating system server executes the application corresponding to the selected icon.

2. The system according to claim 1, wherein the relationship information and the corresponding icon are stored by associating with each other, the relationship information comprises identification information of the application and identification information of the operating system supporting the application.

3. The system according to claim 2, wherein the relationship information and the corresponding icon are stored in the host server.

4. The system according to claim 3, wherein the interface providing module provides the icon interface comprising the stored icons in response to an operation of connecting to the host server by a user.

5. The system according to claim 2, wherein the relationship information and the corresponding icon are stored in the electronic device.

6. The system according to claim 5, wherein the interface providing module provides the icon interface comprising the stored icons after the electronic device is started up.

7. The system according to claim 2, wherein the information analysis module determines the application according to the identification information of the application and determines the operating system supporting the application according to the identification information of the operating system.

8. The system according to claim 2, wherein the execution controlling module configured to trigger the determined operating system server to execute the application corresponding to the selected icon comprises: the execution controlling module sends the identification information of the application and an execution request to the determined operating system server, and then triggers the determined operating system server to execute the corresponding application.

9. The system according to claim 1, wherein the server determination module searches the operating system server according to a network address of the operating system server and accesses to the searched operating system server according to the network address of the determined operating server.

10. The system according to claim 1, wherein the execution controlling module further determines whether the operating system of the host server is the same as the operating system determined by the information analysis module, and controls the host server to execute the application corresponding to the selected icon directly if the operating system of the host server is the same as the operating system determined by the information analysis module.

11. The system according to claim 1, wherein the application of each icon displayed on the icon interface provided by the interface providing module is respectively stored in the corresponding operating system server running the operating system supporting the application.

12. A method for applying a plurality of applications of different operating systems in one electronic device, comprising:
providing an icon interface and displaying the icon interface on a display unit of the electronic device;
detecting operations on the icon interface by a user and determining an icon selected by the user;
determining relationship information corresponding to the selected icon, and analyzing the relationship information to determine an application corresponding to the selected icon and determine an operating system supporting the application;
searching an operating system server running the operating system supporting the application;
triggering the determined operating system server to execute the application corresponding to the selected icon; and
displaying an application interface of the operating system server on the display unit of the electronic device, when the operating system server executes the application corresponding to the selected icon.

13. The method according to claim 12, wherein the relationship information and the corresponding icon are stored by associating with each other, the relationship information comprises identification information of the application and identification information of the operating system supporting the application, the step of determining an application corresponding to the selected icon and determining an operating system supporting the application comprises:
determining the application according to the identification information of the application and determining the operating system supporting the application according to the identification information of the operating system.

14. The method according to claim 12, wherein the step of searching an operating system server running the operating system supporting the application comprises:
searching the operating system server according to a network address of the operating system server and accessing to the searched operating system server according to the network address of the determined operating server.

15. The method according to claim 13, wherein the step of triggering the determined operating system server to execute the application corresponding to the selected icon comprises:
sending the identification information of the application and an execution request to the determined operating system server; and
triggering the determined operating system server to execute the corresponding application.
